(19) United States
(12) Patent Application Publication
(10) Pub. No.: US 2023/0161321 A1
(43) Pub. Date: May 25, 2023

(54) DESIGN SUPPORT SYSTEM, DESIGN SUPPORT METHOD, AND STORAGE MEDIUM

(71) Applicant: Mitsubishi Electric Corporation, Tokyo (JP)

(72) Inventor: Takumi SAEKI, Tokyo (JP)

(73) Assignee: Mitsubishi Electric Corporation, Tokyo (JP)

(21) Appl. No.: 17/917,252

(22) PCT Filed: Jun. 24, 2020
(86) PCT No.: PCT/JP2020/024872

§ 371 Date: Oct. 6, 2022

(51) Int. Cl. G05B 19/4093; G06F 30/20; H04L 67/1001

(52) U.S. Cl. CPC G05B 19/4093; G06F 30/20; H04L 67/1001

(57) ABSTRACT

A server includes a configuration information master file in which a configuration information file output from each of a plurality of engineering apparatuses is reflected, a filter file including an extraction condition for extracting device information which is desired, and an extraction unit that extracts the device information using the filter file from the configuration information file output from each of the engineering apparatuses or the configuration information master file. The server further includes a reflection unit that reflects, in the configuration information master file, the device information extracted by the extraction unit using the filter file from the configuration information file output from each of the engineering apparatuses; and an output unit that outputs, to the engineering apparatuses, the device information extracted by the extraction unit using the filter file from the configuration information master file.

### FIELD

The present disclosure relates to a design support system that supports system design, a design support method, and a design support program.

### BACKGROUND

Engineering apparatuses are used to design a factory automation (FA) system. The engineering apparatuses to be used are different for each design phase when performing FA system design, such as mechanical design, electrical design, and control design. However, even in different design phases, there is partially duplicate work. That is, even in djfferent engineering apparatuses, there is partially duplicate work. Design work in an engineering apparatus is work by manual input by a person. Therefore, a discrepancy in work results of duplicate work in different engineering apparatuses may be caused, due to input errors or the like, between the engineering apparatuses.

As a technique for cooperation between engineering tools, Patent Literature 1 describes an engineering tool cooperation device that allows engineering for accommodating a difference in a data format or the like between engineering tools to operate plant control devices in cooperation with each other.

On the other hand, there is an extensible markup language (XML) file interchange function as a function for eliminating duplicate work in different engineering apparatuses. By using the XML file interchange function, information held in an upstream phase of a design process can be reflected in a downstream phase of the design process without causing a discrepancy. In addition, a change made in the downstream phase can be reflected in the upstream phase. Similarly, by using the XML file interchange function, information held in the downstream phase of the design process can be reflected in the upstream phase of the design process without causing a discrepancy.

CITATION LIST

### Patent Literature

Patent Literature 1: Japanese Patent Application Laid-open No. 2018-73055

### SUMMARY

### Technical Problem

However, in a case of interchanging the XML files including device information described therein between engineering apparatuses, only device information of a device that can be handled by the engineering apparatuses can be processed. Therefore, device information is frequently lost in the interchange of the device information between engineering apparatuses. Such a device that can be handled by an engineering apparatus is a device that can be set in a system design in the engineering apparatus.

For example, a case is assumed where there are an engineering apparatus manufactured by company A and an engineering apparatus manufactured by company B which are downstream engineering apparatuses for performing system design of the same phase which is a downstream phase of a design process. Both the engineering apparatus manufactured by company A and the engineering apparatus manufactured by company B have functional limitations in the system design. The engineering apparatus manufactured by company A cannot set devices manufactured by company B in the system design. The engineering apparatus manufactured by company B cannot set devices manufactured by company A in the system design.

On the other hand, an upstream engineering apparatus for designing an upstream. phase of the design process has a wide range of devices that can be set in the system design, and can set both of devices manufactured by company A and devices manufactured by company B. Therefore, when the engineering apparatus manufactured by company A or the engineering apparatus manufactured by company B imports device information output from the engineering apparatus in an upstream process, and there exists device information not to be processed in each engineering apparatus, the device nformation not to be processed is not imported and is lost.

Then, in a case where the device information changed by the engineering apparatus manufactured by company A or the engineering apparatus manufactured by company B is reflected in the device information held in the upstream engineering apparatus, since part of the device information is lost in the device information output by the engineering apparatus manufactured by company A or company B, fundamentally required device information is not held in the upstream engineering apparatus, which is a problem.

The present disclosure has been made in view of the above, and an object thereof is to obtain a design support system capable of performing, with no loss of information, transmission and reception of information between engineering apparatuses in which devices that can be set in system design are different therebetween.

### Solution to Problem

In order to solve the above-described problem and achieve the object, a design support system according to the present disclosure is a design support system that includes a plurality of engineering apparatuses that supports system design, and a server capable of communicating with the plurality of engineering apparatuses, the design support system being capable of transmitting and receiving, between the plurality of engineering apparatuses and the server, device information specifying devices to be set in a device configuration designed in the system design. Each of the plurality of engineering apparatuses is capable of setting a dfifferent one of the devices in the system design and holds a configuration information file including configuration information which is information on the device configuration created using the device information. The server includes a configuration information master file in which the configuration information file output from each of the plurality of engineering apparatuses is reflected, a filter file including an extraction condition for extracting the device information which is desired, and an extraction unit that extracts the device information using the filter file from the configuration information file output from each of the engineering apparatuses or the configuration information master file. The server further includes a reflection unit that reflects, in the configuration information master file, the device information extracted by the extraction unit using the filter file from the configuration information file output from each of the engineering apparatuses; and an output unit that outputs, to the engineering apparatuses, the device information extracted by the extraction unit using the filter file from the configuration information master file.

### Advantageous Effects of Invention

The design support system according to the present disclosure achieves an effect that it is possible to perform, with no loss of information, transmission and reception of information between engineering apparatuses in which devices that can be set in system design are different therebetween.

### BRIEF DESCRIPTION OF DRAWINGS

FIG. 1 is a diagram illustrating a configuration of a design support system according to a first embodiment.

FIG. 2 is a diagram illustrating a functional configuration of a server of the design support system. according to the first embodiment.

FIG. 3 is a diagram illustrating an example of detailed information of a filter file according to the first embodiment.

FIG. 4 is a diagram illustrating a functional configuration of an engineering apparatus of the design support system according to the first embodiment.

FIG. 5 is a flowchart illustrating a procedure of a first operation performed by the server of the design support system according to the first embodiment.

FIG. 6 is a diagram illustrating an example of a reflection dialog box displayed on a display unit of the server of the design support system according to the first embodiment.

FIG. 7 is a flowchart illustrating a procedure of a second operation performed by the server of the design support system according to the first embodiment.

FIG. 8 is a diagram illustrating an example of an output dialog box displayed on the display unit of the server of the design support system according to the first embodiment.

FIG. 9 is a diagram illustrating an outline of a process of reflecting a configuration information file in a configuration information master file in the design support system according to the first embodiment.

FIG. 10 is a diagram illustrating a reflection result in a case where the configuration nformation file is reflected in the configuration information master file using a filter file in which a pattern of filter information is pattern A in the design support system according to the first embodiment.

FIG. 11 is a diagram illustrating a reflection result in a case where the configuration nformation file is reflected in the coy figuration information master file using the filter file in which a pattern of the filter information is pattern B in the design support system according to the first embodiment.

FIG. 12 is a diagram illustrating a reflection result in a case where the configuration nformation file is reflected in the configuration information master file using the filter file in which a pattern of the filter information is pattern C in the design support system according to the first embodiment.

FIG. 13 is a diagram illustrating an outline of a process of outputting the configuration information file from the configuration information master file in the design support system according to the first embodiment.

### DESCRIPTION OF EMBODIMENTS

Hereinafter, a design support system, a design support method, and a design support program according to an embodiment will be described in detail with reference to the drawings.

### First Embodiment

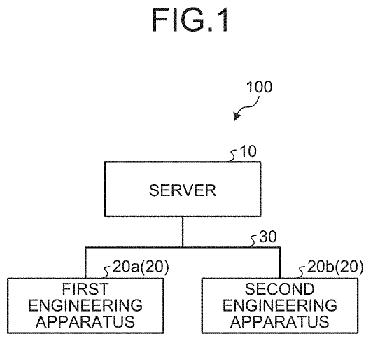

FIG. 1 is a diagram illustrating a configuration of a design support system 100 according to a first embodiment. The design support system 100 is an FA system design support system that supports system design of an FA system including a plurality of FA devices.

In the design support system 100, a server 10 and a plurality of engineering apparatuses 20 are connected via a network 30.

The server 10 is an apparatus that mutually transmits and receives device information of devices used in the system design of the FA system to and from the plurality of engineering apparatuses 20, and holds the device information. The device information transmitted and received between the server 10 and the engineering apparatuses 20 is device information included in configuration information which is information indicating a device configuration. The device configuration is a configuration of an assembled device which is a second device configured by combining and setting a plurality of individual devices each of which is a first device set in the system design. The individual devices are each a device serving as a component constituting the assembled device. The device configuration is created using device information which is information for specifying individual devices set in the system design. Hereinafter, the individual devices may be each simply referred to as a device. Accordingly, the device information in the following description is information for specifying individual devices each of which is the first device set in order to constitute the assembled device which is the second device designed in the system design.

The server 10 is connected to the plurality of engineering apparatuses 20 via the network 30, and can perform wired communication with the plurality of engineering apparatuses 20. Note that the communication between the server 10 and the plurality of engineering apparatuses 20 may be wireless communication. The server 10 is connectea to the plurality of engineering apparatuses 20 only when necessary.

The engineering apparatuses 20 are each an apparatus that supports various designs such as mechanical design, electrical design, and control design for constructing an FA system. In the first embodiment, the design support system 100 includes a first engineering apparatus 20a which is the engineering apparatus 20 that supports system design of different phases in the design of the FA system, and a second engineering apparatus 20b which is the engineering apparatus 20. Note that the design support system. 100 may include three or more engineering apparatuses 20 that support system design in the same phase, or support system design in different phases.

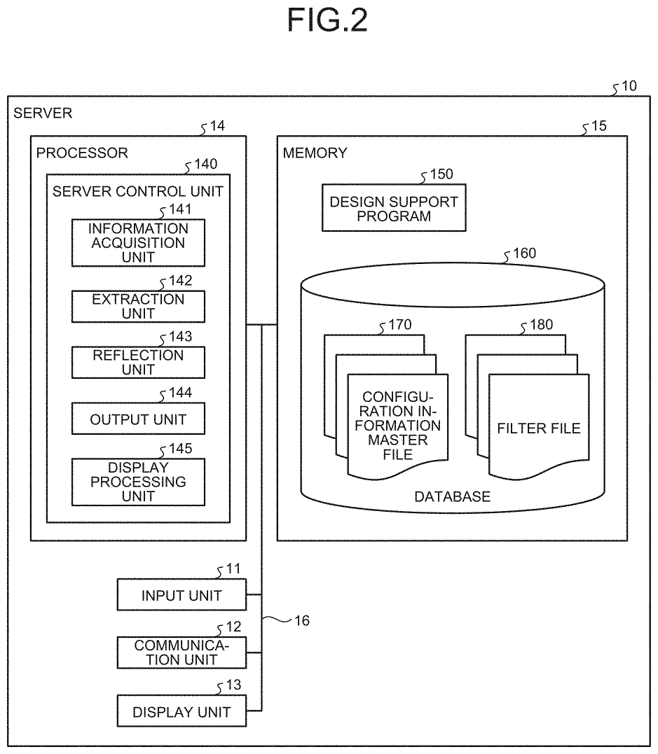

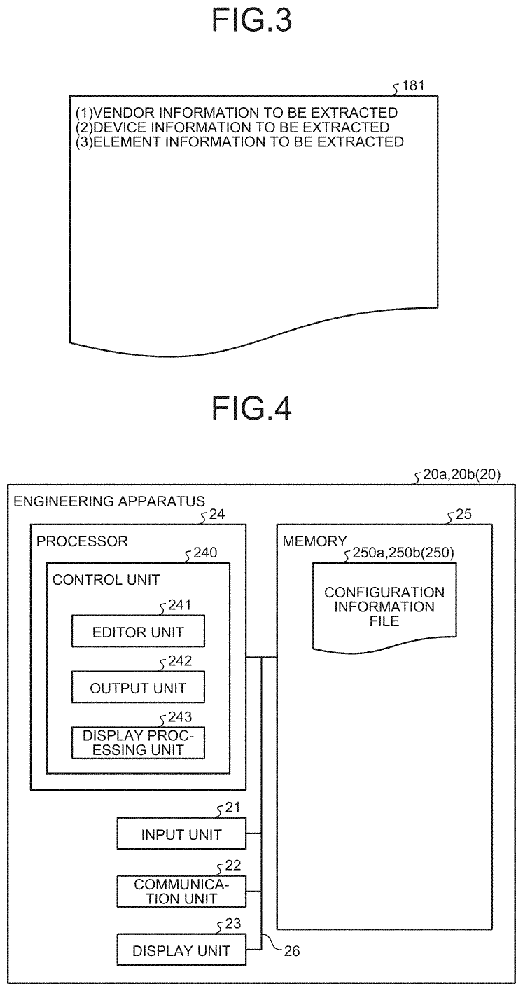

FIG. 2 is a diagram illustrating a functional configuration of the server 10 of the design support system 100 according to the first embodiment. FIG. 3 is a diagram illustrating an example of a Filter file 180 of the design support system 100 according to the first embodiment. FIG. 4 is a diagram illustrating a functional configuration of the engineering apparatus 20 of the design support system 100 according to the first embodiment.

The server 10 includes an input unit 11 to which information is input, a communication unit 12 that performs communication with the plurality of engineering apparatuses 20, a display unit 13 that displays information, a processor 14 that executes various processes, and a memory 15 that stores information. The input unit 11, the communication unit 12, the display unit 13, the processor 14, and the memory 15 are connected via a bus line 16.

Various types of information are input to the input unit 11 from the outside of the server 10. Examples of the input unit 11 include a device such as a keyboard, a mouse, or a touch panel, and information is input by an operation by a user. The communication unit 12 performs bidirectional communication with the plurality of engineering apparatuses 20. The display unit 13 displays information on a screen.

The processor 14 is a central processing unit (CPU), a processing device, an arithmetic device, a mdcroprocessor, a microcomputer, or a digital signal processor (DSP).

The memory 15 includes a random access memory (RAM), a read only memory (ROM), a flash memory, an erasable programmable read only memory (EPROM) or an electrically erasable programmable read only memory (EEPROM (registered trademark)), or a hard disk drive (HDD) as an external storage device or a solid state drive (SSD) as an external storage device. Various data and a design support program which is a processing program of the server 10 are stored in the memory 15. The processor 14 executes the design support program stored in the memory 15.

A design support program describing a processing procedure in the server 10 executed by the processor 14 is loaded into the RAM, and data used by the processor 14 is temporarily held therein. The design support program is a design support program that causes a computer to execute a design support method in which the server 10 transmits and receives, to and from each engineering apparatus 20, device information specifying a device set in system design. Basic input/output system (BIOS) or unified extensible firmware interface (UEFI) as a program for basic: control of the computer is stored in the ROM. The design support program and various data are stored in the external storage device. Note that the design support program may be stored. in the ROM.

The programs stored in the ROM and the external storage device are loaded into the RAM. The processor 14 loads the design support program into the PAM and executes various processes. In the, first embodiment, the processor 14 realizes a function of each processing unit of a server control unit 140 to be described later by executing the design support program.

The design support program may be stored in a computer-readable storage medium. The server 10 may store the design support program stored in the storage medium in the external storage device. The storage medium may be a portable storage medium which is a flexible disk, or a flash memory which is a semiconductor memory. The design support program may be installed on a computer serving as the server 10 from another computer or a server device via a network.

The memory 15 includes a database 160 in which configuration information master files 170 and filter files 180 are stored. The database 160 stores and holds the configuration information master files 170 to be updated by a reflection unit 143 as described later. In addition, the database 160 stores and holds the filter files 180 to be used by an extraction unit 142 to extract device information as described later.

Each configuration information master file 170 is a reflection destination file of a configuration information file 250 to be described later output by the engineering apparatus 20. The configuration information master file 170 is a file serving as a base of the configuration information file 250 output from the server 10 to the engineering apparatus 20 through the filter file 180.

The configuration information master file 170 holds latest configuration information held by the engineering apparatus 20 by taking in device information of the configuration information file 250 held by the engineering apparatus 20 through the filter file 180. That is, the configuration information master file 170 holds device information of a device used for the latest device configuration held by the engineering apparatus 20. Since the configuration information file 250 output by the engineering apparatus 20 is reflected in the configuration information master file 170, information on the configuration information file 250 which is latest and held by the engineering apparatus 20 is described therein. That is, the latest configuration information designed in the engineering apparatus 20 is described in the configuration information master file 170. Therefore, by performing transmission and reception of the device information between each engineering apparatus 20 and the server 10, the content of the configuration information file 250 held by each engineering apparatus 20 and the content of the configuration information master file 170 becomes identical with each other.

The device information is information for specifying individual devices that can be used in system design in the engineering apparatuses 20. In the system design in the engineering apparatuses 20, a device that can be used, that is, a device that can be set is different for each design phase and for each engineering apparatus 20. Therefore, a device that can be used, that is, a device that can be set in the system design, is different for each engineering apparatus 20 used in each design phase in the system design.

That is, in the design support system 100, devices to be used in system design are different between. the first engineering apparatus 20a and the second engineering apparatus 20b. However, devices to be used in the first engineering apparatus 20a are not completely different from devices to be used in the second engineering apparatus 20b. Accordingly, there is a device to be used in both the first engineering apparatus 20a and the second engineering apparatus 20b.

Accordingly, there is a device that can be set in the system design in the first engineering apparatus 20a but cannot be set in the system design in the second engineering apparatus 20b. In addition, there is a device that cannot be set in the system design in the first engineering apparatus 20a but can be set in the system design in the second engineering apparatus 20b. In addition, there is a device that can be set in both the system design in the first engineering apparatus 20a and the system design in the second engineering apparatus 20b.

The filter file 180 is a filter file in which extraction conditions for extracting device information from the configuration information master file 170 or the configuration information file 250 are described. The filter file 180 is used to extract desired device information desired to be reflected in the database 160 when the configuration information file 250 output by the engineering apparatus 20 is reflected in the configuration information master file 170 held in the database 160. The filter file 180 is used to extract only device information required by the user from the configuration information master file 170 when only the device information required by the user is output from the configuration information master file 170 held in the database 160 to the engineering apparatus 20 as an output destination designated by the user.

Accordingly, in the filter file 180 used when the device information is output from the server 10 to each engineering apparatus 20, extraction conditions are described under which device information of a device is not extracted, the device being not settable in the system design in the engineering apparatus 20 as an output destination to which the device information is output.

The configuration information file 250 is an XML file output by each engineering apparatus 20. The configuration information file 250 is a file of configuration information which is information on a device configuration created by the user in the engineering apparatus 20 using device information of a device that can be set by the engineering apparatus 20. That is, in the configuration information file 250, device information of individual devices is described, the individual devices being used for a device configuration created in the system design in the engineering apparatus 20 of the design support system 100. The device information included in the configuration information file 250 includes device information different for each of the enc ineering apparatuses 20 althouGh there is duplicate device information in the plurality of engineering apparatuses 20.

Regarding the filter files 180, the filter file 180 is used which individually corresponds to the engineering apparatus 20 as an output destination of the device information from the configuration information master file 170 and is unique to the engineering apparatus 20 as an output destination. For example, in a case where the engineering apparatus 20 as an output destination of the device information from the configuration information master file 170 is the first engineering apparatus 20a, the unique filter file 180 for the first engineering apparatus 20a is used.

Regarding the filter files 180, one or more filter files 180 are stored in the database 160 for a type of each engineering apparatus 20. That is, one filter file 180 is basically stored in the database 160 for a type of each engineering apparatus 20. However, in a case where it is desired to selectively use a plurality of filter files 180 for a type of the engineering apparatus 20, the plurality of filter files 180 for a type of each engineering apparatus 20 may be stored in the database 160. The filter files 180 are registered in the database 160 by the user via the input unit 11. As illustrated in FIG. 3, the filter file 180 includes, for example, filter information 181.

The filter information 181 is information indicating extraction conditions for extracting only desired device information from the device information included in the configuration information master file 170, or for extracting only desired device information from the device information included in the configuration information file 250 held in each engineering apparatus 20 and to be transmitted to the server 10.

As illustrated in FIG. 3, the filter information 181 includes, as extraction conditions, (1) vendor information to be extracted, (2) device information to be extracted, and (3) element information to be extracted. The vendor information is information on a vendor that provides a device that can be used in the system design in the engineering apparatus 20, and is a company name or the like. The device information is information on a device that can be used in the system design in the engineering apparatus 20, and is a name of the device, a product number of the device, or the like. The element information is an element described in a format of a description method of the device information.

Among the three pieces of information of (1) vendor information to be extracted, (2) device information to be extracted, and (3) element information to be extracted included in the filter information 181, the filter file 180 includes, as extraction conditions, all pieces of information of (1) to (3), the information of (1) and the information of (3), or the information of and the information of (3).

Among the pieces of device information included in the configuration information file 250, only a piece of device information that satisfies all pieces of extraction information of the filter information 181 included in the filter file 180 is device information to be extracted, which is to be extracted through the filter file 180.

FIG. 2 illustrates the functional configuration of the server 10 realized by using the processor 14. The server 10 includes the server control unit 140 that controls processes of the entirety of the server 10. The server control unit 140 includes an information acquisition unit 141, the extraction unit 142, the reflection unit 143, an output unit 144, and a display processing unit 145.

The information acquisition unit 141 transmits, to the reflection unit 143, a file name designated by the user in a reflection dialog box 300 to be described later. In addition, the information acquisition unit 141 transmits, to the output unit 144, a file name designated by the user in an output dialog box 400.

The extraction unit 142 extracts desired device information corresponding to the filter information 181 described in the filter file 180 from the configuration information master file 170 or the configuration information file 250. In a case where the configuration information file 250 output by the engineering apparatus 20 is reflected in the configuration information master file 170 held in the database 160, the extraction unit 142 extracts only desired device information desired to be reflected in the database 160 from the configuration information file 250. In addition, in a case where only device information required by the user is output from the configuration information master file 170 held in the database 160 to the engineering apparatus 20 as an output destination designated by the user, the extraction unit 142 extracts only desired device information required by the user from the configuration information master file 170. Hereinafter, the device information extracted by the extraction unit 142 may be referred to as extracted device information.

The reflection unit 143 reflects, in the configuration information master file 170 of the server 10, the extracted device information extracted by the extraction unit 142 from the configuration information file 250 transmitted from the engineering apparatus 20 on the basis of the filter information 181 described in the filter file 180.

The output unit 144 outputs, to the engineering apparatus 20, the extracted device information extracted from the configuration information master file 170 by the extraction unit 142 on the basis of the filter information 181 described in the filter file 180.

The display processing unit 145 performs a process for display on the display unit 13. The display processing unit 145 performs a process of displaying the output dialog box 400 to be described later or the reflection dialog box 300 to be described later on the display unit 13 in accordance with control from the information acquisition unit 141. That is, the display processing unit 145 performs the process of displaying the reflection dialog box 300 to be described later on the display unit 13 when reflecting the device information of the configuration information file 250 transmitted from the engineering apparatus 20 in the configuration information master file 170. In addition, the display processing unit 145 performs the process of displaying the output dialog box 400 to be described later on the display unit 13 when outputting the device information of the configuration information master file 170 to the engineering apparatus 20.

Furthermore, the display processing unit 145 displays the information received from the engineering apparatus 20 on the display unit 13.

Next, a configuration of the engineering apparatus 20 will be described. As illustrated in FIG. 4, the engineering apparatus 20 includes an input unit 21 to which information is input, a communication unit 22 that performs communication with the plurality of engineering apparatuses 20, a display unit 23 that displays information, a processor 24 that executes various processes, and a memory 25 that stores information. The input unit 21, the communication unit 22, the display unit 23, the processor 24, and the memory 25 are connected via a bus line 26.

Various types of information are input to the input unit 21 from the outside of the engineering apparatus 20. Examples of the input unit 21 include a device such as a keyboard, a mouse, or a touch panel, and information is input by an operation by the user. The communication unit 22 performs bidirectional communication with the server 10. The display unit 23 displays information on a screen.

The processor 24 is a CPU, a processing device, an arithmetic device, a microprocessor, a microcomputer, or a DSP.

The memory 25 stores the configuration information file 250. The memory 25 includes a PAM, a ROM, a flash memory, an EPROM or EEPROM, or an HDD or an SSD. An engineering program which is a processing program of the engineering apparatus 20 is stored in the memory 25. The processor 24 executes the engineering program stored in the memory 25. The engineering program is a program that causes a computer to execute system design in the engineering apparatus 20.

The fHrst engineering apparatus 20a stores a first configuration information file 250a which is the configuration information file 250 in the memory 25. The second engineering apparatus 20b stores a second configuration information file 250b which is the configuration information file 250 in the memory 25. The first configuration information file 250a and the second configuration information file 250b are created in the XML language, i.e., the same language.

FIG. 4 illustrates the functional configuration of the engineering apparatus 20 realized by using the processor 24. The engineering apparatus 20 includes a control unit 240 that controls processes of the entirety of the engineering apparatus 20. The control unit 240 includes an editor unit 241, an output unit 242, and a display processing unit 243.

The editor unit. 241 displays a system design screen on the display unit 23, and performs a process of creating or editing a system design document in response to an operation by the user performed on the input unit 21. The editor unit 241 stores the created or edited system design document in the memory 25. The function of the editor unit 241 of creating and editing a system design document is similar to an editor function of a general engineering tool. The edhtor unit 241 creates, as part of a process of creating the system design document, the configuration information file 250 which is a file of configuration information including device information.

The output unit 242 outputs the configuration information file 250 created by the editor unit 241 to the server 10. In addition, the output unit 242 outputs the configuration information file 250 created by the editor unit 241 for interchanging the configuration information file 250 between the engineering apparatuses 20.

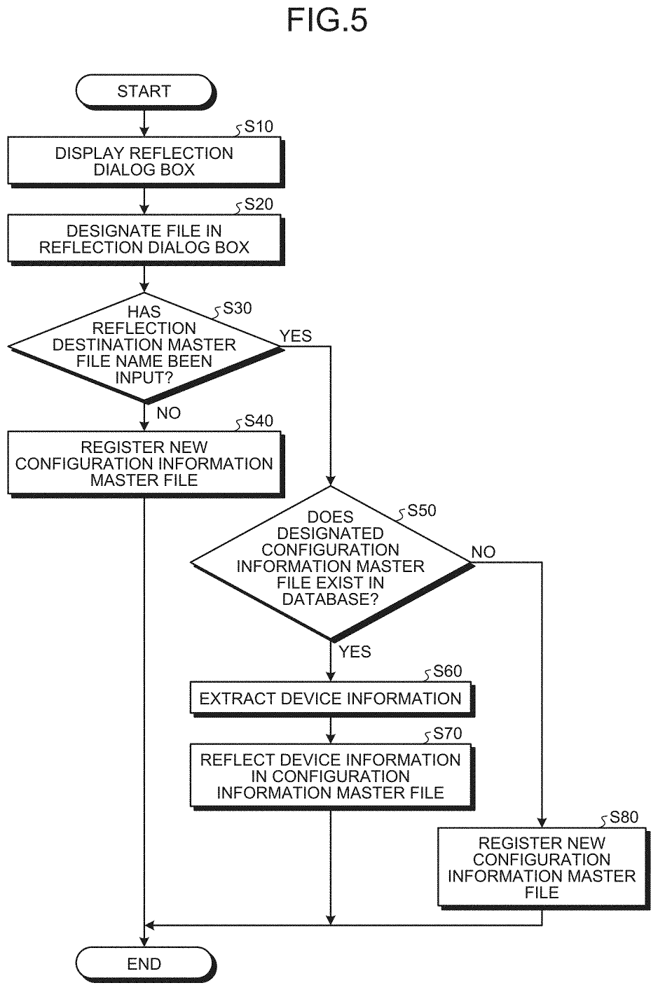

Next, an operation of the design support system 100 will be described. FIG. 5 is a flowchart illustrating a procedure of a first operation performed by the server 10 of the design support system 100 according to the first embodiment. The first operation is an operation of uploading the configuration information file 250 held by the engineering apparatus 20 to the server 10 and reflecting the configuration information file 250 in the configuration information master file 170. In more detail, the first operation is an operation of reflecting device information included in the configuration information file 250 held by the engineering apparatus 20 in the configuration information master file 170.

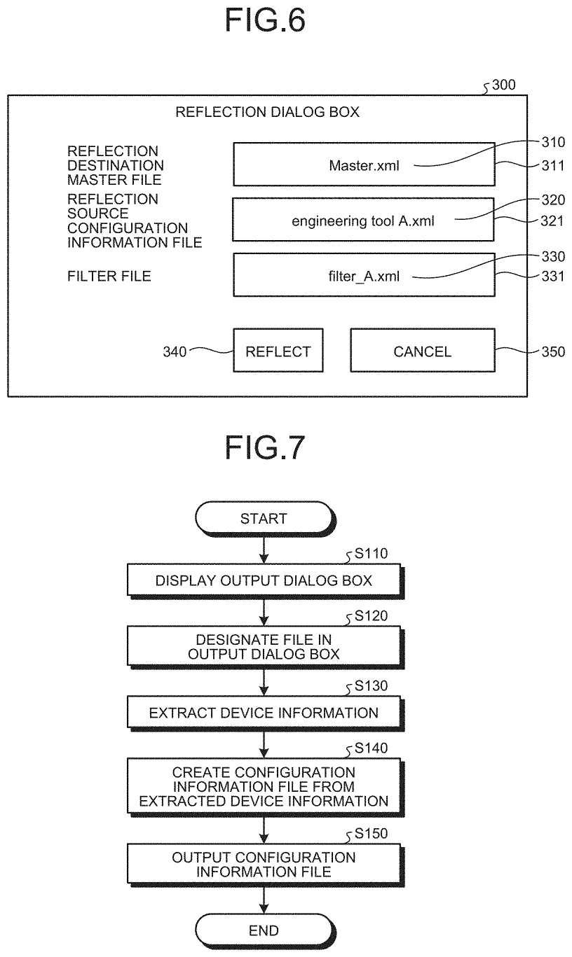

In step S10, the display processing unit 145 of the server 10 displays the reflect ion dialog box 300 on the display unit 13. FIG. 6 is a diagram illustrating an example of the reflection dialog box 300 displayed on the display unit 13 of the server 10 of the design support system 100 according to the first embodiment.

The reflection dialog box 300 is a screen on which a file is designated, the file being used when the configuration information file 250 is reflected in the configuration information master file 170. Specifically, in the reflection dialog box 300, a reflection destination master file, a reflection source configuration information file, and a filter file are designated. The reflection dialog box 300 includes a reflection destination master file input region 311 to which a reflection destination master file name 310 is input, a reflection source configuration information file input region 321 to which a reflection source configuration information file name 320 is input, and a filter file input region 331 to which a filter file name 330 is input.

Here, the reflection destination master file is the configuration information master file 170 as a reflection destination in which the user desires to reflect the configuration information file 250. The reflection destination master file name 310 is a file name of the reflection destination master file.

The reflection source configuration information file is the configuration information file 250 as a reflection source which the user desires to reflect in the configuration information master file 170. The reflection source configuration information file name 320 is a file name of the reflection source configuration information file.

The filter file is the filter file 180 used when the configuration information file 250 is reflected in the configuration information master file 170. The filter file name 330 is a file name of the filter file.

Next, in step S20, a file is designated in the reflection dialog box 300. Specifically, the display processing unit 145 receives information on input items in the reflection dialog box 300, such as the reflection source configuration information file name 320, and displays the received information in the reflection dialog box 300. The information on the input items in the reflection dialog box 300 is input from the input unit 11 by an operation by the user.

The reflection destination master file is designated by inputting the reflection destination master file name 310 to the reflection destination master file input region 311. The reflection source configuration information file is designated by inputting the reflection source configuration information file name 320 to the reflection source configuration information file input region 321. The filter file is designated by inputting the filter file name 330 to the filter file input region 331.

Here, the reflection source configuration information file name 320 is required to be input as an item to be input to the reflection dialog box 300. In a case where the reflection destination master file name 310 has been input to the reflection destination master file input region 311, it is required to input the filter file name 330 in the filter file input region 331.

After the information on each input item is input to the reflection dialog box 300, the server control unit 140 proceeds to a reflection process of the configuration information file 250 when receiving reflection instruction information. That is, the information acquisition unit 141 acquires, from the display processing unit 145, the information on the input items input in the reflection dialog box 300. After the information on each input item is input to the reflection dialogbox 300, the server control unit 140 stops the process when receiving cancel instruction information. That is, the display processing unit 145 closes the reflection dialog box 300, and a series of processes ends.

When the, user selects a reflect button 340 in the reflection dialog box 300, the reflection instruction information is input to the server 10. When the user selects a cancel button 350 in reflection dialog box 300, the cancel instruction information is input to server 10.

Next, in step S30, the information acquisition unit 141 determines whether the reflection destination master file name 310 has been input to the reflection destination master file input region 311. If the reflection destination master file name 310 has not been input to the reflection destination master file input region 311, No is selected in step S30, and the process proceeds to step 540 if the reflection destination master file name 310 has been input to the reflection destination master file input region 311, Yes is selected in step S30, and the process proceeds to step S50.

In step S40, the configuration information file 250 output from the engineering apparatus 20 is registered and stored in the database 160 as a new configuration information master file 170. Specifically, the reflection unit 143 creates the new configuration information master file 170 including the configuration information file 250 output from the engineering apparatus 20. Here, the configuration information file 250 output from the engineering apparatus 20 is the configuration information file 250 for which the reflection source configuration information file name 320 has been input to the reflect on source configuration information fle input region 321. The reflection unit 143 registers and stores the created new configuration information master file 170 in the database 160.

Then, the reflection unit 143 notifies the user that the new configuration information master file 170 has been registered in the database 160, and ends a series of reflection processes. Specifically, the reflection unit 143 outputs, to the display processing unit 145, new registration information inddcating that the new configuration information master fle 170 has been registered in the database 160. When receiving the new registration information, the display processing unit 145 displays, on the basis of the new registration information, the registration of the new configuration information master file 170 in the database 160 on the display unit 13, thereby notifying the user of the registration.

In step S50, the information acquisition unit 141 determines whether the configuration information master file 170 designated in the reflection dialog box 300 exists in the database 160. That is, the information acquisition unit 141 determines whether the configuration information master file 170 corresponding to the reflection destination master file name 310 input to the reflection destination master file input region 311 exists in the database 160. If the information acquisition unit 141 determines that the configuration information master file 170 designated in the reflection dialog box 300 exists in the database 160, Yes is selected in step S50, and the process proceeds to step S60. If the information acquisition unit 141 determines that the configuration information master file 170 designated in the reflection dialog box 300 does not exist in the database 160, No is selected in step S50, and the process proceeds to step S80.

In step S60, the device nformation is extracted. Specifically, the extraction unit 142 acquires, from the information acquisition unit 141 the reflection source configuration information file name 320 and the filter file name 330 designated in the reflection dialog box 300. Next, the extraction unit 142 acquires, from the engineering apparatus 20, the configuration information file 250 corresponding to the acquired reflection source configuration information file name 320. In addition, the extraction unit 142 acquires the filter file 180 corresponding to the acquired filter file name 330 from the database 160.

Then, the extraction unit 142 extracts device information corresponddng to the filter information 181 as the extraction conditions included in the filter file 180 from the configuration information file 250. The extraction unit 142 discards a piece of the device information that does not correspond to the filter information 181 among pieces of the device information included in the configuration information file 250.

Next, in step S70, the device information extracted from the configuration information file 250 by the extraction unit 142 is reflected in the configuration information master file 170. Specifically, the reflection unit 143 acquires, from the extraction unit 142, the device information extracted from the configuration information file 250 by the extraction unit 142, reflects the acquired device information in the configuration information master file 170 designated as the reflection destination master file in the reflection dialog box 300, and ends a series of reflection processes. That is, the reflection unit 143 updates the configuration information master file 170 using the acquired device information.

In each piece of the device information, unique identification information is described. In a case where pieces of device informatjon that include identical identification information exist in both the device information extracted from the configuration information file 250 and the device information included in the configuration information master file 170, the reflection unit 143 updates the device information included in the configuration information master file 170 to the device information extracted from the configuration information file 250.

In a case where there exists device information that includes no identical identification information and exists only in the configuration information file 250, the reflection unit 143 reflects the device information as new device information in the configuration information master file 170. That is, the reflection unit 143 adds, as new device information to the configuration information master file 170, the device information extracted from the configuration information file 250 and not included in the configuration information master file 170.

In addition, in a case where there exists device information that includes no identical identification information, exists only in the configuration information master file 170, and corresponds to the filter information 181 included in the filter file 180, the reflection unit 143 determines that the device information has been deleted from the configuration information file 250 held in the engineering apparatus 20. Therefore, the reflection unit 143 deletes the device information from the configuration information master file 170. The reflection unit 143 performs any one of the above-described processes on all pieces of the device information acquired from the extraction unit 142, and thus ends the reflection processes.

On the other hand, in step 880, the configuration information file 250 output from the engineering apparatus 20 is registered and stored in the database 160 as a new configuration information master file 170. Specifically, the reflection unit 143 creates the new configuration information master file 170 including the configuration information file 250 output from the engineering apparatus 20 here, the configuration information file 250 output from the engineering apparatus 20 is the configuration information file 250 for which the reflection source configuration information file name 320 has been input to the reflection source configuration information file input region 321. The reflection unit 143 registers and stores the created new configuration information master file 170 in the database 160.

Then, the reflection unit 143 notifies the user that the new configuration information master file 170 has been registered in the database 160, and ends a series of reflection processes.

Next, another operation of the design support system 100 will be described. FIG. 7 is a flowchart illustrating a procedure of a second operation performed by the server 10 of the design support system 100 according to the first embodiment. The second operation is an operation of outputting only device information required by the user from the configuration information master file 170 held by the server 10 to the engineering apparatus 20.

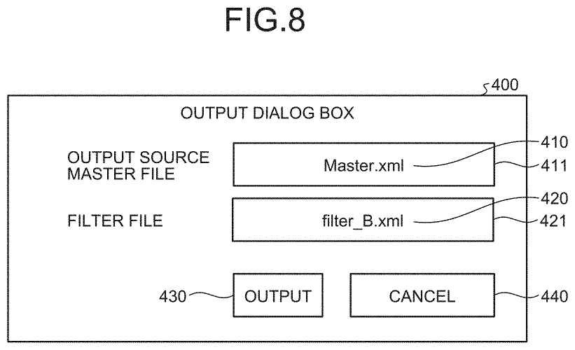

In step S110, the display processing unit 145 of the server 10 displays the output dialog box 400 on the display unit 13. FIG. 8 is a diagram illustrating an example of the output dialog box. 400 displayed on the display unit 13 of the server 10 of the design support system 100 according to the first embodiment.

The output dialog box 400 is a screen on which a file is designated, the file being used when only the device information required by the user is output from the configuration information master file 170 to the engineering apparatus 20. Specifically, in the output dialog box 400, an output source master file and a filter file are designated. The output dialog box 400 includes an output source master file input region 411 to which an output source master file name 410 is input, and a filter file input region 421 to which a Filter file name 420 is input.

Here, the output source master file is the configuration information master file 170 as an output source which the user desires to output to the engineering apparatus 20. The output source master file name 410 is a file name of the output source master file.

The filter file is the filter file 180 used when only the device information required by the user is output from the configuration information master file 170 to the engineering apparatus 20. The filter file name 420 is a file name of the filter file.

Next, in step S120, a file is designated in the output dialog box 400. Specifically, the display processing unit 145 receives information on input items in the output dialog box 400, such as the output source master file name 410, and displays the received information in the output dialog box 400. The information on the input items in the output dialog box 400 is input from the input unit 11 by an operation by the user.

The output source master file is designated by inputting the output source master file name 410 to the output source master file input region 411. The filter file is designated by inputting the filter file name 420 to the filter file input region 421. Here, regarding the filter file, the filier fjle 180 is used which individually corresponds to the engineering apparatus 20 as an output destination of the device information from the configuration information master file 170 and is unique to the engineering apparatus 20 as an output destination. For example, in a case, where the engineering apparatus 20 as an output destination of the device information from the configuration information master file 170 is the first engineering apparatus 20a, the unique filter file 180 for the first engineering apparatus 20a is used.

Specifically, the filter file 180 which is unique and individually corresponds to the engineering apparatus 20 as an output destination includes the filter information 181 for extracting only configuration information of a device that can be used in system design in the engineering apparatus 20 as an output destination. That is, the filter file 180 which is unique and individually corresponds to the engineering apparatus 20 as an output destination includes information indicating extraction conditions for extracting only the configuration information of a device that can be used in the system design in the engineering apparatus 20 as an output destination.

After the information on each input item is input to the output dialog box 400, the server control unit 140 proceeds to an output process of the configuration information master file 170 when receiving output instruction information. That is, the information acquisition unit 141 acquires, from the display processing unit 145, the information on the input items input in the output dialog box 400. After the information on each input item is input to the output dialog box 400, the server control unit 140 stops the process when receiving cancel instruction information. That is, the display processing unit 145 closes the output dialog box 400, and a series of processes ends.

When the user selects an output button 430 in the output dialog box 400, the output instruction information is input to the server 10. When the user selects a cancel button 440 in output dialog box 400, the cancel instruction information is input to server 10.

In step S130, the device information is extracted specifically, the extraction unit 142 acquires, from the information acquisition unit 141, the output source master file name 410 and the filter file name 420 designated in the output dialog box 400. Next, the extraction unit 142 acquires the configuration information master file 170 corresponding to the acquired output source master file name 410 from the database 160. In addition, the extraction unit 142 acquires the filter file 180 corresponding to the acquired filter file name 420 from the database 160.

Then, the extraction unit 142 extracts the device information corresponding to the filter information 181 as the extraction conditions included in the filter file 180 from the configuration information master file 170. The extraction unit 142 discards a piece of the device information that does not correspond to the filter information 181 among pieces of the device information included in the configuration information master file 170.

In step S140, a new configuration information file 250 is created from the device information extracted by the extraction unit 142. Specifically, the output unit 144 acquires the device information extracted by the extraction unit 142 from the extraction unit 142. Then, the output unit 144 creates the new configuration information file 250 including the acquired device information.

In step S150, the output unit 144 outputs the created new configuration information file 250 to the engineering apparatus 20 as an output destination. The output unit 144 performs the above-described output processes on all pieces of the device information acquired from the extraction unit 142, and thus ends a series of output processes.

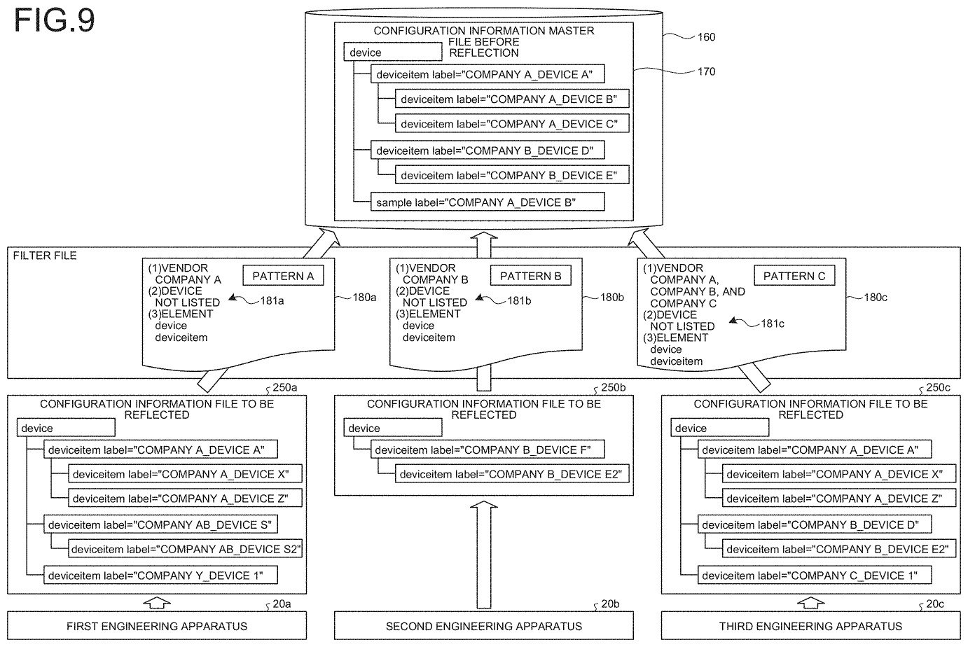

Next, a process in the design support system. 100 will be described with reference to a specific example. FIG. 9 is a diagram illustrating an outline of a process of reflecting the configuration information file 250 in the configuration information master file 170 in the design support system. 100 according to the first embodiment. Here, a case will be described where the design support system 100 includes the first engineering apparatus 20a, the second engineering apparatus 20b, and a third engineering apparatus 20c.

In FIG. 9, a tree configuration in which “device”, and “deviceitem label” and “sample label” arranged below the “device” are described corresponds to a device configuration. Information described in the tree configuration corresponds to the configuration information. The “device” is a name of the device configuration.

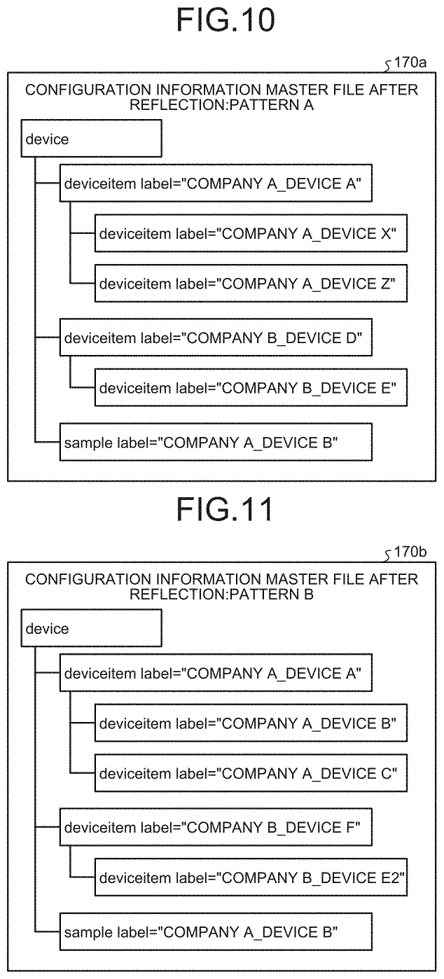

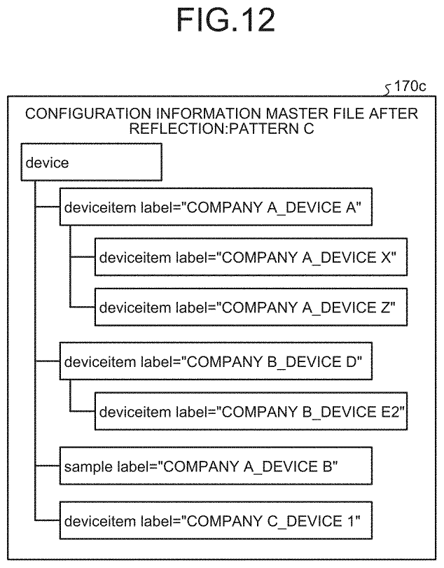

FIG. 10 is a diagram illustrating a reflection result in a case where the configuration information file 250 is reflected in the configuration information master file 170 using the filter file 180 in which a pattern of the filter information 181 is pattern A in the design support system 100 according to the first embodiment. FIG. 11 is a diagram illustrating a reflection result in a case where the configuration information file 250 is reflected in the configuration information master file 170 using the filter file 180 in which a pattern of the filter information 181 is pattern B in the design support system 100 according to the first embodiment. FIG. 12 is a diagram illustrating a reflection result in a case where the configuration information file 250 is reflected in the configuration information master file 170 using the filter file 180 in which a pattern of the filter information. 181 is pattern C in the design support system 100 according to the first embodiment.

(First Pattern)

First, a case will be described where the first configuration information file 250a output by the First engineering apparatus 20a is reflected in the configuration information master file 170. In a case where a first filter file 180a in which first filter information 181a of the content of pattern A is described is selected in the reflection dialog box 300 described above, device information in which the vendor is “company A” and the element is “device” or “deviceitem” is extracted from the first configuration information file 250a by the extraction unit 142. The element is the above-described (3) element information to be extracted.

Therefore, respective pieces of device information of “company A_device A”, “company A_device X”, and “company A_device 7” corresponding to the vendor and element conditions are extracted from the first configuration information file 250a. Then, the extracted pieces of device nformation are reflected in the configuration information master file 170 by the reflection unit 143.

Here, in the configuration information master file 170 before rflection, devices corresponding to the content described in the first filter information 181a of pattern A are “company A_device A”, “company A_device B”, and “company A_device C”. The device information to be reflected does not include respective pieces of device information of the “device B” and the “device C”. Therefore, the reflection unit 143 determines that the respective pieces of device information of the “device B” and the “device C” have been deleted in the first configuration information file 250a held by the first engineering apparatus 20a, and deletes and reflects the respective pieces of device information of the “device B” and the “device C” in the configuration information master file 170. That is, the reflection unit 143 deletes respective pieces of device information of “company A_device B” and “company A_device C” from the configuration information master file 170.

The device A exists in both the first configuration information file 250a and the configuration information master file 170 before reflection. Therefore, the reflection unit 143 reflects the content of the device information of the device A included in the first configuration information file 250a in the device information of the device A included in the configuration information master file 170. The “device X” and the “device Z” exist only in the first configuration information file 250a. Therefore, the reflection unit 143 newly adds and reflects respective pieces of device information of the “device X” and the “device Z” in the configuration information master file 170 as the device information of the additional devices.

Device information of devices other than the device whose vendor i.s “company A” does not correspond to the content described in the first filter file 180a. Therefore, the device information of devices other than the device whose vendor i.s “company A” is not extracted from the first configuration information file 250a and not reflected in the configuration information master file 170. By performing the reflection processes, the configuration information master file 170 is updated to the content. described in “configuration information master file after reflection pattern A” which is a configuration information master file after reflection 170a illustrated in FIG. 10.

(Second Pattern)

Next, a case will be described where the second configuration information file 250b output by the second engineering apparatus 20b is reflected in the configuration information master file 170. In a case where a second filter file 180b in which second filter information 181b of the content of pattern B is described is selected in the reflection dialog box 300 described above, device information in which the vendor is “company B” and the element is “device” or “deviceitem” is extracted from the second configuration information file 250b by the extraction unit 142.

Therefore, respective pieces of device information of “company B_device F” and “company B_device E2” corresponding to the vendor and element conditions are extracted from the second configuration information file 250b. Then, the extracted pieces of device information are reflected in the configuration information master file 170 by the reflection unit 143.

Here, in the configuration information master file 170 before reflection, devices corresponding to the content described in the second filter information 181b of pattern B are “company B device D”, and “company B device E”. The device information to be reflected does not include respective pieces of device information of the “device D” and the “device B”. Therefore, the reflection unit 143 determines that the respective pieces of device information of the “device D” and the “device B” have been deleted in the second configuration information file 250b held by the second engineering apparatus 20b, and deletes and reflects the respective pieces of device information of the “device D” and the “device B” in the configuration information master file 170. That is, the reflection unit 143 deletes respective pieces of device information of “company B_device D” and “company B_device E” from the configuration information master file 170.

The “device F” and the “device E2” exist only in the second configuration information file 250b. Therefore, the reflection unit 143 newly adds and reflects respective pieces of device information of the “device F” and the “device E2” in the configuration information master file 170 as the device information of the additional devices.

Device information of devices other than the device whose vendor is “company B” does not correspond to the content described in the second filter file 180b. Therefore, the device information of devices other than the device whose vendor is “company B” is not extracted from the second configuration information file 250b and not reflected in the configuration information master file 170. By performing the reflection processes, the configuration information master file 170 is updated to the content described in “configuration information master file after reflection: pattern. B” which is a configuration information master file after reflection 170b illustrated in FIG. 11.

(Third Pattern)

Next, a case will be described where a third. configuration information file 250c output by the third engineering apparatus 20c is reflected in the configuration information master file 170. In a case where a third. filter file 180c in which third filter information 181c of the content of pattern C is described is selected in the reflection dialog box 300 described above, device information in which the vendor is any one of “company A”, “company B”, and “company C” and the element is “device” or “deviceitem” is extracted from the third configuration information file 250c by the extraction unit 142.

Therefore, respective pieces of device information of “company A_device A”, “company A_device X”, “company A_device Z”, “company B_device C”, “company B_device P2”, and “company C_device 1” corresponding to the vendor and element conditions are extracted from the third configuration information file 250c. Then, the extracted pieces of deviceinformation are reflected in the cconfiguration information master file 170 by the reflection unit 143.

Here, in the configuration information master file 170 before reflection, devices of “company A” corresponding to the content described in the third filter information 181c of pattern C are “company A_device A”, “company A_device B”, and “company A_device C”. The device information to be reflected does not include respective pieces of device information of the “device B” and the “device C”. Therefore, the reflection unit 143 determines that the respective pieces of device information of the “device B” and the “device C” have been deleted in the third configuration information file 250c held by the third engineering apparatus 20c, and deletes and reflects the respective pieces of device information of the “device B” and the “device C” in the configuration information master file 170. That is, the reflection unit 143 deletes respective pieces of device information of “company A_device B” and “company A_device C” from the configuration information master file 170.

The device A of “company A” exists in both the third configuration information fjle 250c and the configuration information master file 170 before reflection. Therefore, the reflection unit 143 reflects the content of the device information of the device A included in the third configuration information file 250c in the device information of the device A included in the configuration information master file 170. The “device X” and the “device Z” exist only in the third configuration information file 250c. Therefore, the reflection unit 143 newly adds and reflects respective pieces of device information of the “device X” and the “device Z” in the configuration information master file 170 as the device information of the additional devices.

In addition, in the configuration information master file 170 before reflection, devices of “company B” corresponding to the content described in the third filter information 181c of pattern C are “company B_device D”, and “company B_device E”. The device information to be reflected does not include the device information of the “device E”. Therefore, the reflection unit 143 determines that the device information of the “device E” has been deleted in the third configuration information file 250c held by the third engineering apparatus 20c, and deletes and reflects the device information of the “device F” in the configuration information master file 170. That is, the reflection unit 143 deletes the device information of “company B_device E” from the configuration information master file 170.

The device D exists in both the third. configuration information file 250c and the configuration information master file 170 before reflection. Therefore, the reflection unit 143 reflects the content of the device information of the device D included in the third. configuration information file 250c in the device information of the device D included in the configuration information master file 170. The “device E2” exists only in the third configuration information file 250c. Therefore, the reflection unit 143 newly adds and reflects the device information of the “device E2” in the configuration information master file 170 as the device information of the additional device.

In addition, a device of “company C” corresponding to the content described in the third filter information 181c of pattern C is “company C_device 1”. The “company C” exists only in the third configuration information file 250c. Therefore, the reflection unit 143 newly adds and reflects the device information of the “company C_device 1” in the configuration information master file 170 as the device information of the additional device. By performing the reflection processes, the configuration information master file 170 is updated to the content described in “configuration information master file after reflection pattern C” which is a configuration information master file after reflection 170c illustrated in FIG. 12.

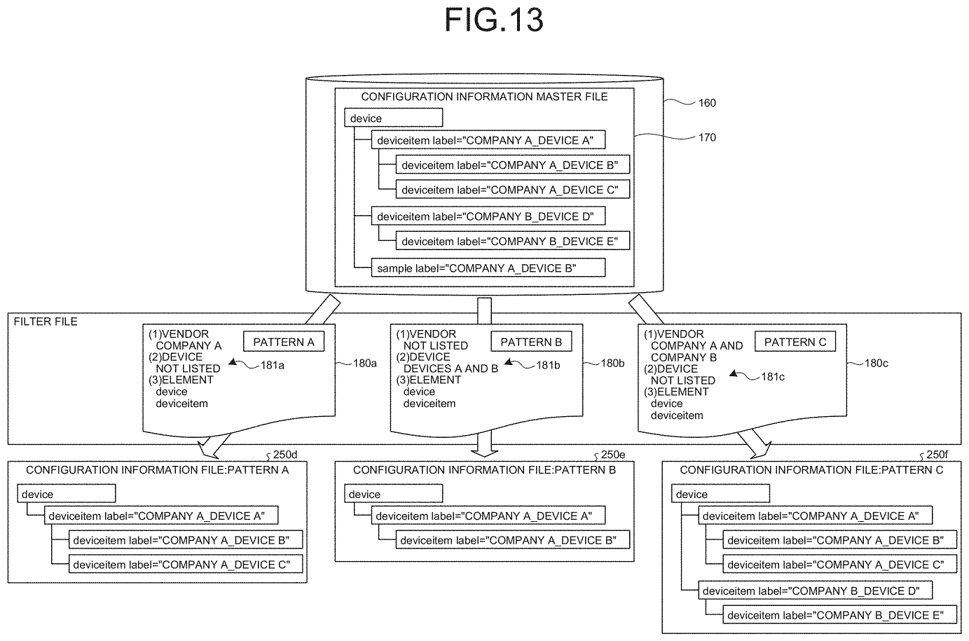

FIG. 13 is a diagram illustrating an outline of a process of outputting the configuration information file 250 from the configuration information master file 170 in the design support system 100 according to the first embodiment. Here, a case will be described where a fourth configuration information file 250d is output. In a case where the first filter file 180a in which the first filter information 181a of the content of pattern A is described is selected in the output dialog box 400 described above, the device information in which the vendor is “company A” and the element is “device” or “deviceitem” is extracted from the configuration information master file 170 by the extraction unit 142.

Therefore, respective pieces of device information of “company A_device A”, “company A_device B”, and “company A_device C” corresponding to the vendor and element conditions are extracted from the configuration information master file 170. The output unit 144 creates a new fourth configuration information file 250d including the extracted pieces of device information, and outputs the new fourth configuration information file 250d to the engineering apparatus 20 as an output destination.

Since the first filter information 181aof pattern. A does not include the definition of “company B”, the device information of “company B” is not extracted from the configuration information master file 170. Accordingly, the device information of “company B” is not included in the fourth configuration information file 250d to be output. Similarly, regarding the device information of “company A_device B” in which the element is “sample”, the vendor condition corresponds to the first filter information 181a, but the element does not correspond thereto, and thus the device information is not extracted and not included in the fourth configuration information file 250d.

If the second fjiter file 180b is selected in the output dialog box 400, a fifth configuration information file 250e is output to a device outside the server 10 by a process similar to that described above. If the third filter file 180c is selected in the output dialog box 400, a sixth configuration information file 250f is output to a device outside the server 10 by a process similar to that described above.

Note that, in the above description, a case has been described where the server 10 and the engineering apparatuses 20 are each realized by a personal computer, but the server 10 and the engineering apparatuses 20 may be each configured as a dedicated apparatus.

In the design support system 100 configured as described above, it is possible by interposing the server 10 to perform, with no loss of device information, transmission and reception of device information between the plurality of engineering apparatuses 20 in which devices that can be set in system design are different therebetween.

For example, a case is assumed where there are the first engineering apparatus 20a as an engineering apparatus manufactured by company A, the second engineering apparatus 20b as an engineering apparatus manufactured by company B, both of which are downstream engineering apparatuses for performing system design in the same phase which is a downstream phase or a design process, and the third engineering apparatus 20c which is an upstream engineering apparatus for performing system design in an upstream phase of the design process. The third engineering apparatus 20c is the engineering apparatus 20 manufactured by, for example, company D which is another device manufacturer different from companies A, B, and C. Both the first engineering apparatus 20a and the second engineering apparatus 20b have functonal limitations in the system design. The first engineering apparatus 20a cannot set devices manufactured by company B in the system. design. The second engineering apparatus 20b cannot set devices manufactured by company A in the system design. The third engineering apparatus 20c can set devices manufactured by company A, devices manufactured by company B, and devices manufactured by company C in the system. design. The first engineering apparatus 20aand the second engineering apparatus 20b cannot set devices manufactured by company C in the system design.

For example, the configuration information master file 170 is assumed in which there exist device information of devices manufactured by company B that cannot be used in the system design in the first engineering apparatus 20a but can be used in the system design in the second engineering apparatus 20b and device information of devices manufactured by company A.

In a case where the configuration information file 250 output from the first engineering apparatus 20a is reflected in this configuration information master file 170, by extracting the device information using the Filter file 180 for the first engineering apparatus 20a, only the device information that can be used in the system design in the first engineering apparatus 20a is reflected and edited in the configuration information master file 170. Therefore, even when the device information of devices manufactured by company B that cannot be processed by the first engineering apparatus 20a does not exist in the configuration information file 250, the configuration information file 250 output from the first engineering apparatus 20a can be reflected in the configuration information master file 170 with no loss of the device information of devices manufactured by company B that can be processed by the second engineering apparatus 20b. That is, in the configuration information master file 170, the device information that can be processed by the second engineering apparatus 20b is held without being deleted.

The same applies to a case where the configuration information file 250 output from the second engineering apparatus 20b is reflected in the configuration information master file 170 in which there exist the device information of devices manufactured by company A that cannot be used in the system design in the second engineering apparatus 20b but can be used in the system design in the first engineering apparatus 20a and the device information of devices manufactured by company B. That is, the design support system 100 can reflect the configuration information file 250 output from the second engineering apparatus 20b in the configuration information master file 170 with no loss of the device information of devices manufactured by company A that can be processed by the first engineering apparatus 20a.

The same applies to a case where the configuration information file 250 output from the third engineering apparatus 20c is reflected in the configuration information master file 170 in which there exist the device information of devices manufactured by company A, the device information of devices manufactured by company B, and device information of devices manufactured by company C. That is, the design support system 100 can reflect, in the configuration information master file 170, the device information of devices manufactured by company C included in the configuration information file 250 with no loss of the device information of devices manufactured by company A and the device information of devices manufactured by company B.

As a resule, in the design support system 100, since the server 10 can hold the latest configuration information and device information in the system design in the plurality of engineering apparatuses 20 of the design support system 100, the device information is not lost in the interchange of the device information between the first engineering apparatus 20a and the second engineering apparatus 20b as downstream engineering apparatuses, and the third engineering apparatus 20c as an upstream engineering apparatus. That is, in the design support system 100, even when the configuration information file 250 is uploaded from each of the engineering apparatuses 20 to the database 160, the configuration information file 250 can be reflected, by using the filter file 180, in the configuration information master file 170 with no loss of the device information of the configuration information master file 170.

Therefore, even in a case where the configuration information master file 170 held in the database 160 is reflected in the third engineering apparatus 20c, the device information in which no piece of the device information is lost can be reflected in the third engineering apparatus 20c. In addition, even in a case where the device information required in the third engineering apparatus 20c is output to the third engineering apparatus 20c, the device information in which no piece or the device information is lost can be output to the third engineering apparatus 20c.

As a result, in the system design of the first engineering apparatus 20a, the second engineering apparatus 20h, and the third engineering apparatus 20c, there arises no extra process such as device information check work, and the system design can be performed in parallel in the first engineering apparatus 20a, the second engineering apparatus 20b, and the third engineering apparatus 20c, which makes it easy to develop the system in parallel.

That is, according to the design support system 100, in the transmission and reception of the device information of the configuration information between the plurality of engineering apparatuses 20 and the server 10, the device information to be transmitted and received can be controlled by the filter files 180, and the device information of all the devices used in the system design in the plurality of engineering apparatuses 20 can be reliably managed by the configuration information master files 170, and therefore it is possible to prevent the loss of the device information due to the interchange of the files including the configuration information, which makes it easy to develop the system in parallel.

In addition, in the design support system 100, when it is desired to change the device information of the configuration information master file 170 in the first engineering apparatus 20a, only the device information of a device that can be used in the first engineering apparatus 20a can be extracted from the configuration information master file 170 by using the filter file 180 dedicated to the first engineering apparatus 20a. Then, a file including only the extracted device information can be created and output to the first engineering apparatus 20a as the configuration information file 250. That is, in the design support system 100, the first engineering apparatus 20a can acquire only the device information required by the user from the configuration information master file 170 by using the filter file 180.

Therefore, in the design support system 100, unrequired device information that cannot be processed by the first engineering apparatus 20a is not read when the device information included in the configuration information master file 170 is imported by the first engineering apparatus 20a. That is, when the first engineering apparatus 20a imports the configuration information file 250, only the device nformation that can be used is described in the configuration information file 250, and thus the device information is not lost in the first engineering apparatus 20a regarding the device information included in the configuration information file 250.

As a result, in the design support system 100, an error caused by reading unrequired device information that cannot be processed by the first engineering apparatus 20a is prevented from occurring, so that an import process not interrupted due to the error, and system design work in the first engineering apparatus 20a is not delayed.

In addition, in the design support system 100, since the loss of the device information due to the import in the first engineering apparatus 20a is prevented, the configuration information file 250 in which the device information is loqt is not output from the first engineering apparatus 20a to the server 10 and imported in the server 10. As a result, there is no occurrence of a problem that required device information is unintentionally deleted from the server 10 due to the import by the server 10 of the configuration information file 250 output from the first engineering apparatus 20a and in which the device information is lost.

Then, by preparing a filter file for each engineering apparatus 20, each engineering apparatus 20 can execute the function of the server 10 described above on other devices in the design support system 100.

In the transmission and reception of the device information between the first enqjneerinq apparatus 20a and the server 10, a method is possible in which the device information that cannot be processed by the first. engineering apparatus 20a is also held in the first. engineering apparatus 20a as an object to be imported by the first engineering apparatus 20a. However, in a case where the device nformation is changed in the server 10, an unintended change occurs.

Thus, the design support system. 100 according to the first embodiment achieves an effect that it is pos,sible to perform, with no loss of information, transmission and reception of information between engineering apparatuses in which devices that can be set in system design are different therebetween.

The configurations described in the embodiment above are merely examples and can be combined with other known technology and part of the configurations can be omitted or modified without departing from the gist thereof.

### REFERENCE SIGNS LIST

10 server; 11, 21 input unit; 12, 22 communication unit; 13, 23 display unit; 14, 24 processor; 15, 25 memory; 16, 26 bus line; 20 engineering apparatus; 20a first engineering apparatus; 20b second engineering apparatus; 20c third engineering apparatus; 30 network; 100 design support system; 140 server control unit; 141 information acquisition unit; 142 extraction unit; 143 reflection unit; 144 output unit; 145 display processing unit; 160 database; 170 configuration information master file; 170a, 170b, 170c configuration information master file after reflection; 180 filter file; 180a first filter file; 180b second filter file; 180c third filter file; 181 filter information; 181a first filter information; 181b second filter information; 181c third filter information; 240 control unit; 241 editor unit; 242 output unit; 243 display processing unit; 250 configuration information file; 250afjrst configuration information file; 250b second configuration information file; 250c third configuration information file; 250d fourth configuration information file; 250e fifth configuration information file; 250f sixth configuration inform tion file; 300 reflection dialog box; 310 reflection destination master file name; 311 reflection destination master file input region; 320 reflection source configuration information file name; 321 reflection source configuration jnformation file input region; 330, 420 filter file name; 331, 421 filter file input region; 340 reflect button; 350, 440 cancel button; 400 output dialog box; 410 output source master file name; 411 output source master file input region; 430 output button.

1. A design support system comprising a plurality of engineering apparatuses to support system design, and a server capable of communicating with the plurality of engineering apparatuses, the design support system being capable of transmitting and receiving, between the plurality of engineering apparatuses and the server, device information specifying devices to be set in a device configuration designed in the system design, wherein
each of the plurality of engineering apparatuses is capable of setting a different one of the devices in the system design and holds a configuration information file including configuration information that is information on the device configuration created using the device information, and
the server includes:
a configuration information master file in which the configuration information file output from each of the plurality of engineering apparatuses is reflected;
a filter file including an extraction condition for extracting the device information that is desired;
an extraction circuitry to extract the device information using the filter file from the configuration information file output from each of the engineering apparatuses or the configuration information master file;
an output circuitry to output, to the engineering apparatuses, the device information extracted by the extraction circuitry using the filter file from the configuration information master file and
a reflection circuitry to reflect, in the configuration information master file, the device information extracted by the extraction circuitry using the filter file from the configuration information file output from each of the engineering apparatuses.

2. The design support system according to claim 1, wherein
the reflection circuitry adds, to the configuration information master file, a piece of the device information that is not included in the configuration information master file among pieces of the device information extracted by the extraction circuitry using the filter file from the configuration information file output from each of the engineering apparatuses.

3. The design support system according to claim 1, wherein
in the filter file used when the device information is output from the server to the engineering apparatuses, the extraction condition is described under which the device information of the devices is not extracted, the devices being not settable in system design in the engineering apparatuses as output destinations to which the device information is output.

4. A design support method for transmitting and receiving, between a plurality of engineering apparatuses that support system design and a server capable of communicating with the plurality of engineering apparatuses, device information specifying devices to be set in a device configuration designed in the system design, wherein
each of the plurality of engineering apparatuses is capable of setting a different one of the devices in the system design and holds a configuration information file including configuration information that is information on the device configuration created using the device information, and
the server executes:
extracting the device information using a filter file including an extraction condition for extracting the device information that is desired from a configuration information master file in which the configuration information file output from each of the plurality of engineering apparatuses is reflected, or the configuration information file output from each of the engineering apparatuses;
outputting, to each of the engineering apparatuses, the device information extracted using the filter file from the configuration information master file and
reflecting, in the configuration information master file, the device information extracted using the filter file from the configuration information file output from each of the engineering apparatuses.

5. A non-transitory computer-readable storage medium having a design support program stored therein, the design support program causing a computer constituting a server to execute a design support method for transmitting and receiving, between a plurality of engineering apparatuses that support system design and the server capable of communicating with the plurality of engineering apparatuses, device information specifying devices to be set in a device configuration designed in the system design, wherein
each of the plurality of engineering apparatuses is capable of setting a different one of the devices in the system design and holds a configuration information file including configuration information that is information on the device configuration created using the device information, and
the computer is caused by the design support program to execute:
extracting the device information using a filter file including an extraction condition for extracting the device information that is desired from a configuration information master file in which the configuration information file output from each of the plurality of engineering apparatuses is reflected, or the configuration information file output from each of the engineering apparatuses;
outputting, to each of the engineering apparatuses, the device information extracted using the filter file from the configuration information master file and
reflecting, in the configuration information master file, the device information extracted using the filter file from the configuration information file output from each of the engineering apparatuses.

6. The design support system according to claim 2, wherein
in the filter file used when the device information is output from the server to the engineering apparatuses, the extraction condition is described under which the device information of the devices is not extracted, the devices being not settable in system design in the engineering apparatuses as output destinations to which the device information is output.
